(19) United States
(12) Patent Application Publication
(10) Pub. No.: US 2003/0017023 A1
(43) Pub. Date: Jan. 23, 2003

(54) Expansion dowel

(76) Inventors: Heinz Bisping, Augsburg (DE); Alois Kolbl, Buchloe (DE); Jurgen Wieser, Kaufering (DE); Claudia Zimmerer, Augsburg (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/194,532

(22) Filed: Jul. 12, 2002

(30) Foreign Application Priority Data
Jul. 17, 2001 (DE) 101 34 604.2

(51) Int. Cl. F16B 13/06

(52) U.S. Cl. 411/60.1

(57) ABSTRACT

An expansion dowel formed of an expansion sleeve (1) slotted at least along a portion of its longitudinal extent, starting from an end of the expansion sleeve (1) facing in a setting direction (S) of the expansion dowel, and an expansion member (2) formed of at least two segments (7, 8), receivable in the through-bore (3) of the expansion sleeve (1), and having an outer profile (6) widening in the setting direction (5) for expanding the expansion sleeve (1) and a bore (4) provided with an inner thread (5).

### BACKGROUND OF THE INVENTION

1. Field of the Invention

The present invention relates to an expansion dowel formed of a cylindrical expansion sleeve having a through-bore and slotted at least along a portion of its longitudinal extent, starting from an end of the expansion sleeve facing in a setting direction of the expansion dowel, and an expansion member receivable in the through-bore of the expansion sleeve and having an outer profile widening in the setting direction for expanding the expansion sleeve, and a bore provided with an inner thread.

2. Description of the Prior Art

Expansion dowels of the type described above find different applications and can be set in a concrete constructional part, e.g., in form of a segmental anchor. The expansion dowel is inserted into a bore formed in the constructional part. As load application means, e.g., a bolt connectable with the expansion member and having a shaped outer profile can be used. A load, which acts in a direction opposite the insertion direction of the dowel, causes the expansion member to be pulled into the through-bore of the expansion sleeve that, as a result of the expansion member being pulled in, expands radially, becoming anchored in the bore of the constructional part.

An expansion dowel with an expansion member, which is pulled into an expansion sleeve, is disclosed in U.S. Pat. No. 2,955,504. The expansion member has a bore with an inner thread and cooperates with a screw which serves as load application means.

The advantage of forming the load application means, which serves also as fastening means, as a screw consists in that such load application means insures a simple preassembly of the screw with the dowel by inserting the screw through the expansion sleeve, with expansion member being screwed onto the screw at the setting direction end of the sleeve.

The drawback of the known expansion dowel consists in that during the preassembly, the expansion member has to be screwed onto the screw. This takes some time, on one hand, and on the other hand, the use of a sufficiently long screw is required as, otherwise, the screwing of the expansion member onto the screw would be very difficult if at all possible.

### OBJECT OF THE INVENTION

Accordingly, an object of the present invention is to provide an expansion dowel with an expansion member which is pulled into an expansion sleeve, which dowel can be easily and reliably preassembled with the load application means.

Another object of the present invention is to provide an expansion dowel with an expansion member, which is pulled into an expansion sleeve, which dowel can be economically produced.

### SUMMARY OF THE INVENTION

These and other objects of the present invention, which will become apparent hereinafter, are achieved by forming the expansion member of at least two segments.

The formation of the expansion member of two or more segments insures a very easy preassembly by joining the segments together at a desired location on the load application means. As a result, the preassembly is substantially independent from the outer profile of the load application means, and the time-consuming operation of screwing of the expansion member onto the load application means is eliminated.

Advantageously, the adjacent segments are connected with each other by a hinge to prevent loss of one or more segments. In addition, the use of hinges for connecting the adjacent segments facilitates handling of the elements during preassembly of the expansion member on the load application element. When the expansion member is formed of several segments and all of the segments are connected by hinges, the expansion member can be handled as if it is formed as a one-piece member.

According to a particularly advantageous embodiment of the present invention, at least one of the segments is connected with an adjacent segment by a connection element. Thereby, an expansion member, which is formed of separate segments, can advantageously be releasably mounted on the load application means.

The expansion sleeve is preferably also formed of at least two expansion segments, which further contributes to a simple and convenient preassembly.

Advantageously, the adjacent expansion segments of the expansion sleeve are also connected by hinges which facilitates mounting of the expansion sleeve on the load application means.

Advantageously, at least one of the expansion segments is connected with an adjacent expansion segment by a connection element. Thereby, the expansion sleeve, which is formed of separate expansion segments, can be releasably mounted on the load application element.

Advantageously, the expansion sleeve is formed of metal at least partially covered by plastics.

The expansion member is also advantageously formed of metal covered at least partially by plastics, which permits molding of additional elements on the expansion member such as, e.g., connection elements.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

In the drawings:

FIG. 1 shows a perspective view of an expansion dowel according to the present invention in an unfolded condition;

FIG. 2 shows a perspective view of the dowel shown in FIG. 1 in a folded condition; and

FIG. 3 shows a longitudinal cross-section view of expansion dowel shown in a condition in which it is mounted on a load application element.

### DETAILED DESCRIPTION OF THE PREFERRED EMBODIMENT

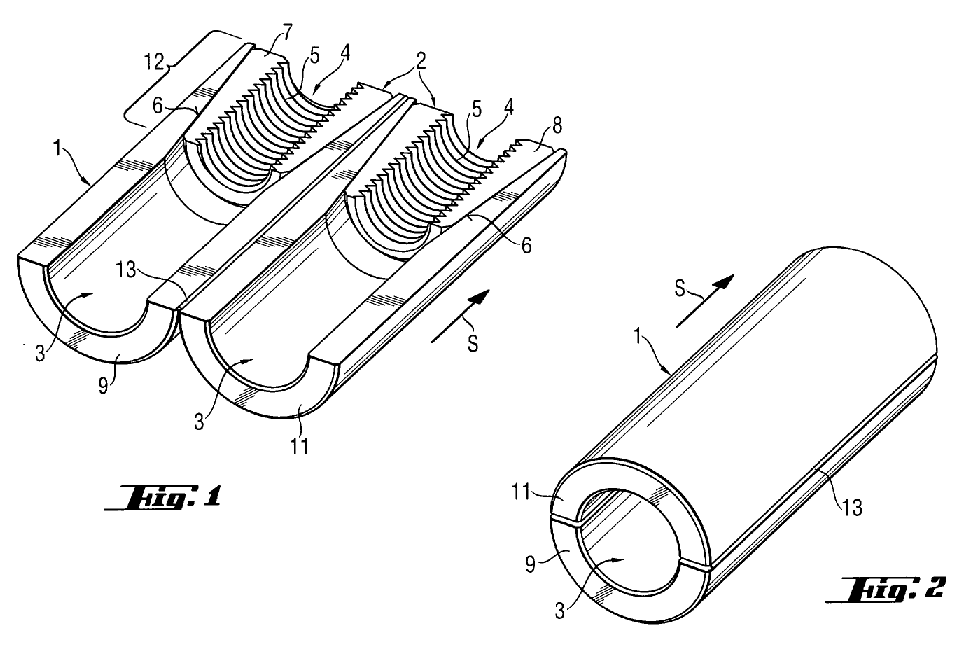

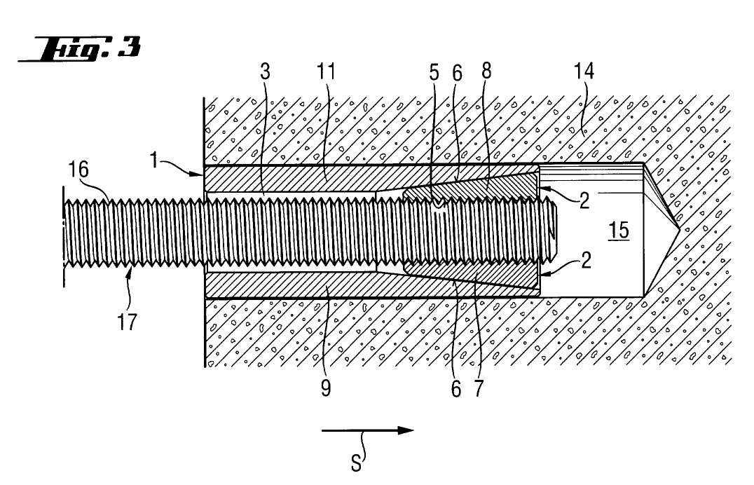

An expansion dowel according to the present invention, which is shown in FIGS. 1-3, includes a cylindrical expansion sleeve 1 having a through-bore 3 and slotted at least along a portion of a longitudinal extent of the expansion sleeve 1, starting from its end face facing in a setting direction S. The expansion sleeve 1 is expanded by an expansion member 2 that is pulled into the through-bore 3 in a direction opposite the setting direction S.

The expansion member 2 is formed of two segments 7 and 8 and has a bore 4 extending in the setting direction S. The bore 4 is provided with an inner profile, preferably, in form of an inner thread 5. The outer profile 6 of the expansion member 2 conically widens in the setting direction S.

The expansion sleeve 1 is formed of two expansion segments 9, 11 and has, in a setting direction end region of the through-bore 3, a receiving region 12 having an inner conical profile complementary to the outer conical profile 6 of the expansion member 2. The expansion member 2 is displaceably supported in the receiving region 12 of the expansion sleeve 1. The expansion member 2 can, e.g., be releasably connected with the expansion sleeve 1 by a predetermined breaking point (not shown). The two expansion segments 9 and 11 can be connected with each other by a hinge 13 formed, e.g., as a plastic hinge. The two expansion segments 9, 11 can further be connected with each other by appropriate connection means (not shown for the sake of clarity) that can be formed, e.g., as snap-connection means.

The expansion sleeve 1 is formed of metal that is covered with plastics. The expansion member 2 can be formed of metal, plastics, or metal at least partially covered with plastics.

FIG. 3 shows an expansion dowel according to the present invention which is set in a bore 15 formed in a constructional component 14. A bolt 17, which is formed with an outer profile 16, serves as load application means. The outer profile 16, which is formed as an outer thread, form lockingly engages the inner thread 5 of the expansion member 2. A load, which is applied to the bolt 17 and acts in the direction opposite the setting direction S causes displacement of the expansion member 2, which is located in the receiving region 12 of the through-bore 3, in the direction opposite the setting direction. The displacement of the expansion member 2 results in the radial expansion of the expansion sleeve 1. As a result, the expansion dowel becomes frictionally anchored in the bore 15 of the constructional component 14.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. An expansion dowel, comprising a cylindrical expansion sleeve (1) having a through-bore (3) and slotted at least along a portion of a longitudinal extent thereof, starting from an end of the expansion sleeve (1) facing in a setting direction (S) of the expansion dowel; and an expansion member (2) formed of at least two segments (7,8), receivable in the through-bore (3) of the expansion sleeve (1), and having an outer profile (6) widening in the setting direction (5) for expanding the expansion sleeve (1), and a bore (4) provided with an inner thread (5).

2. An expansion dowel according to claim 1, further comprising hinge means for connecting the at least two adjacent segments (7, 8) which form the expansion member (2).

3. An expansion dowel according to claim 1, further comprising connection means for connecting the at least two segment (7, 8) which form the expansion member (2).

4. An expansion dowel according to claim 1, wherein the expansion sleeve (1) is formed of at least two expansion segments (9, 11).

5. An expansion dowel according to claim 4, further comprising hinge means (12) for connecting the at least two expansion segments (9, 11).

6. An expansion dowel according to claim 4, further comprising connection means for connecting the at least two expansion segments (9, 11).

7. An expansion dowel according to claim 1, wherein the expansion sleeve (1) is formed of metal at least partially covered with plastics.

8. An expansion dowel according to claim 1, wherein the expansion member (2) is formed of metal at least partially covered with plastics.
